(19) United States
(12) Patent Application Publication
(10) Pub. No.: US 2011/0293735 A1
(43) Pub. Date: Dec. 1, 2011

(54) COMPOSITION OF PESTICIDE

(76) Inventor: MAO-SONG CHEN, Yonghe City (TW)

(21) Appl. No.: 12/788,322

(22) Filed: May 27, 2010

(51) Int. Cl. A01N 63/02; A01P 3/00; A01P 7/04

(52) U.S. Cl. 424/535

(57) ABSTRACT

A composition of pesticide is a composed of banana oil, pepper powder, urea, and milk powder. Banana oil is composed of ethyl acetate, n-butyl acetate, n-butanol, ketone, benzol, and xylene. Banana oil is diluted with water at a proper ratio. Pepper powder is added to banana oil to provide an excellent effect of pest killing. Urea is diluted with water at a proper ratio. Milk powder is added to urea to provide protection to plant leaves. With such a composition, a practical improvement of being environmentally conservative, toxicant free, and pollution free is realized.

### (a) TECHNICAL FIELD OF THE INVENTION

The present invention generally relates to a composition of pesticide, and more particularly to a composition of pesticide that is environmentally conservative, toxicant-free, and pollution-free.

### (b) DESCRIPTION OF THE PRIOR ART

Pesticides are very indispensable for the modern agriculture. Pesticides are used to eliminate and suppress the breeding and propagation of pests and bacteria and also to help cultivation and growth of crops and improve quality of the crops. Farmers commonly use pesticides to obtain better harvest.

One of the commonly known pests for rice, cabbage, and Chinese kale is diamond-back moth, of which the scientific name is Plutella xylostella (Linnaeus). Diamond-back moth is constantly present all year round in Taiwan, and the prosperous season is between December and March. The imago of diamond-back moth lays eggs on veins of leaves and the eggs hatch out and become larva that feeds on the leaves. The larva, when being touched, will spin to suspend itself. Once growing up, the larva becomes diamond-back moth, which has a body length of around 4.5-6.5 mm.

To expel diamond-back moth in order to protect the leaves of vegetables, farmers often spray pesticides that kill diamond-back moth on the leaves of vegetables. Due to the factor of economic costs, chemically synthesized pesticides are often used. However, this leads to certain risks of being exposed to the pesticides for the general consumers enjoying the delicious tastes of vegetables and fruits.

The conventional pesticides show several disadvantages for which improvement might needed. Experiments indicate that feeding on vegetables with residues of pesticides sticking thereon for a long time may cause various acute or chronic diseases of human bodies. Although the pesticides, once entering human body, may be digested and decomposed by enzymes of human body, yet damage to the organs and tissues of human body may be gradually built up due to such the metabolism process of the pesticides.

Thus, it is desired to have a novel pesticide that overcomes the above discussed problems.

### SUMMARY OF THE INVENTION

In view of the above mentioned problems of the conventionally used pesticides, the present invention aims to provide a composition of pesticide that is environmentally conservative, toxicant-free, and pollution-free. The primary objective of the present invention is to provide a composition of pesticide, which is a composed of banana oil, pepper powder, urea, and milk powder. Banana oil is composed of ethyl acetate, n-butyl acetate, n-butanol, ketone, benzol, and xylene. Banana oil is diluted with water at a proper ratio. Pepper powder is made by drying and grinding pepper fruit into powder. Urea is diluted with water at a proper ratio. Milk powder is mixed with urea to provide protection to leaves of leaf vegetables. Pepper powder and milk powder are added to the diluted banana oil and urea at proper ratios. With such a composition, the present invention provides an effect of pest killing and is a toxicant-free and pollution-free pesticide. With such a technology, the problem of the conventional pesticides that might cause potential risk to human health can be overcome and a practical improvement of being environmentally conservative, toxicant free, and pollution free is realized.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram schematically showing a composition of pesticide according to a preferred embodiment of the present invention.

FIG. 2 is a schematic view showing a process for manufacturing the pesticide according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

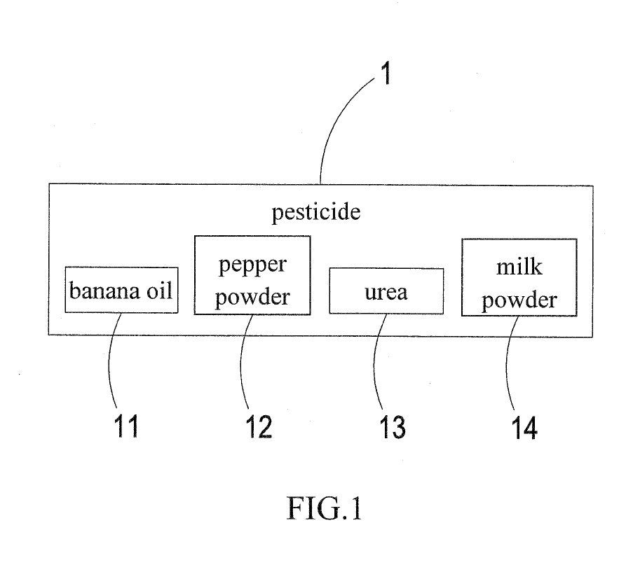

Referring to FIG. 1, a block diagram schematically shows a composition of pesticide according to the present invention is given. As shown in the drawing, the pesticide according to the present invention, generally designated at 1, comprises the following constituents:

Banana oil 11 is composed of ethyl acetate, n-butyl acetate, n-butanol, ketone, benzol, and xylene. The chemical name of banana oil 11 is isoamyl acetate. Banana oil 11 is of volatility and is a volatile solvent mixture. Banana oil 11 is mixed with water at a predetermined ratio. The mixture ratio between banana oil 11 and water can be from 1:80 to 1:100.

Pepper powder 12 is added, with a proper amount, to the diluted banana oil 11 for mixture at a ratio of for example 1:1. Pepper powder 12 is made by drying and grinding pepper fruits into powder. Pepper powder 12 provides an effect of suppressing the generation of anti-body in pests.

Urea 13, of which the chemical formula is CO(NH₂)₂, is also called carbamide. Urea 13 is a physiologically neutral fertilizer and is used by mixing, at a predetermined ratio, with water. The mixture ratio between urea 13 and water is from 1:500 to 1:2000.

Milk powder 14 is added, with a proper amount, to the diluted urea 13 for mixture at a ratio of for example 1:1. The mixture of milk powder 14 and urea 13 provides an effect of protection of surface of leaf.

The pesticide 14 provided by the present invention is composed of the above mentioned four constituents.

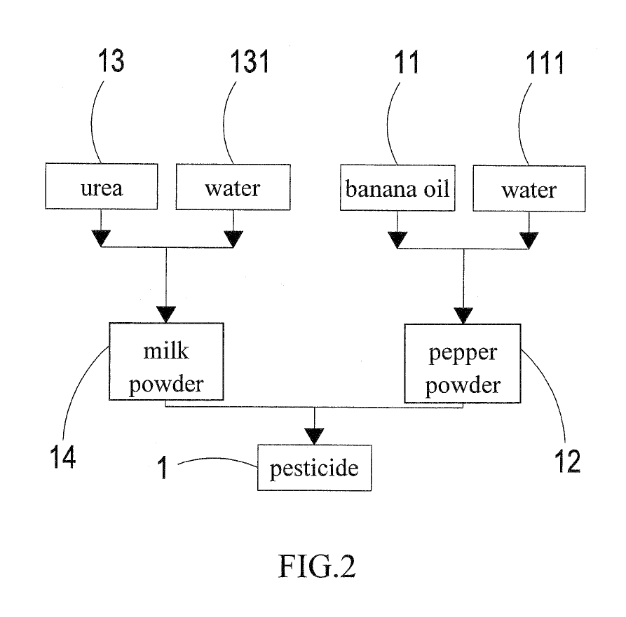

Also referring to FIG. 2, which schematically shows the process for manufacturing the pesticide according to the present invention, the pesticide 1 according to the present invention is made by mixing the above mentioned four constituents to provide the effect of pest killing. In the manufacturing process, banana oil 11 is mixed with water 111 at a ratio ranging from 1:80 to 1:100 for dilution. The diluted banana oil 11 is then added with pepper powder 12. Urea 13 is mixed with water 131 at a ratio ranging from 1:500 to 1:2000 for dilution and the diluted rear 13 is added with milk powder 14. The pesticide 1 according to the present invention is completed by mixing the mixture of banana oil and pepper powder and the mixture of urea and milk powder.

The pesticide 1 of the present invention provides shows an excellent effect for killing diamond-back moth, wherein the diluted banana 11 provides the effect of pest killing, pepper powder 12 functions to suppress the generation of anti-body in the pest, and the mixture of urea 13 and milk powder 14 offer protection of the leaves of leaf vegetables. In this way, excellent effect of pest killing can be obtained for crops that receive the pesticide 1 of the present invention sprayed thereon and development of resistance against the pesticide of the present invention by the pests is difficult, and further, the leaves of vegetables can be better protected by the pesticide of the present invention due to the constituents of urea 13 and milk powder 14.

Experiments reveal that the pesticide 1 of the present invention also offers the following advantages.

(1) The pesticide helps suppressing or eliminating harmful bacteria/fungi/alga for Agaricus Blazei Murill and Enokitake mushrooms, including for example green bacteria or molds, and facilitate growth of crops.

(2) Without proper application of agricultural chemicals, grapes are susceptible to be infected by ripe rot or other rot diseases, which are generally not curable for the current technology of agricultural chemicals. Without being properly taken care of, grapes may rot, leading to poor harvest. The pesticide 1 of the present invention, when applied, forms protection on surfaces of grapes, protecting from being infected by the diseases.

(3) Sago palms (Cycas revoluta) are often attacked by a pest called scale insect. The pesticide 1 of the present invention is also effective in killing or suppressing scale insects.

(4) The present invention also offers good results in suppressing or eliminating other pests and/or diseases, such as clamworm, downy mildew, and blue bacteria.

To this point, it is appreciated that the key point that the composition of pesticide according to the present invention can overcome the problems of the conventional pesticides is that the composition of pesticide provided by the present invention is composed of banana 11, pepper powder 12, urea 13, and milk powder 4. Banana oil 11 is composed of ethyl acetate, n-butyl acetate, n-butanol, ketone, benzol, and xylene. Banana oil 11 is diluted with water at a proper ratio. Pepper powder 12 is made by drying and grinding pepper fruits into powders. Pepper powder 12, when mixed with banana oil 11, provides an excellent effect of pest killing. Urea 13 is diluted with water at a proper ratio. Milk powder 14 is mixed with urea 13 to provide protection to the leaves of leaf vegetables. In such a composition, all constituents are organic and are environmentally conservative, toxicant free, and pollution free. Thus, the present invention raises no burden to the environment and offers a practical improvement of being environmentally conservative, toxicant free, and pollution free.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-3. (canceled)

4. A composition of pesticide comprising:
banana oil composed of ethyl acetate, n-butyl acetate, n-butanol, ketone, benzol and xylene mixed with water at a ratio of 1:80 to 1:100;
pepper powder made by drying and grinding pepper fruits into powder for providing an effect of suppressing generation of anti-body in pests;
urea mixed with water at a ratio of 1:500 to 1:2000;
milk powder mixed with said urea at a ratio of 1:1 for providing an effect of protection of surface of leaf;
wherein said banana oil, said pepper powder, said urea and said milk powder are mixed to form said pesticide.

5. A method of manufacturing a composition of pesticide comprising steps of:
preparing banana oil composed of ethyl acetate, n-butyl acetate, n-butanol, ketone, benzol and xylene;
mixing said banana oil with water at a ratio of 1:80 to 1:100:
adding pepper powder to said banana oil for a first mixture at a ratio of 1:1, said pepper powder being made by drying and grinding pepper fruits into powder for providing an effect of suppressing generation of anti-body in pests;
preparing urea;
mixing said urea with water at a ratio of 1:500 to 1:2000;
adding milk powder with said urea for a second mixture at a ratio of 1:1;
mixing said first mixture and said second mixture to form said pesticide.
